(19) United States
(12) Patent Application Publication
(10) Pub. No.: US 2005/0204295 A1
(43) Pub. Date: Sep. 15, 2005

(54) Low Vision Enhancement for Graphic User Interface

(75) Inventors: Garald Voorhees, St. Petersburg, FL (US); Dan Simkovitz, St. Petersburg, FL (US); Roberto Cordero, St. Petersburg, FL (US)

Correspondence Address: SMITH & HOPEN PA, 15950 BAY VISTA DRIVE, SUITE 220, CLEARWATER, FL, 33760, US

(73) Assignee: FREEDOM SCIENTIFIC, INC., St. Petersburg, FL (US)

(21) Appl. No.: 10/906,854

(22) Filed: Mar. 9, 2005

Related U.S. Application Data
(60) Provisional application No. 60/521,197, filed on Mar. 9, 2004.

(51) Int. Cl. G06F 3/00

(52) U.S. Cl. 715/747; 715/865; 715/744; 715/746

(57) ABSTRACT

A computer software product for optimizing a graphic user interface for use by an individual with low vision, the software product including a configuration module, the configuration module adapted to modify the appearance of a graphic display indicia selected from the group consisting of cursors and carets, the display indicia further comprising a plurality of modifiable characteristics selected from the group consisting of height, width, line thickness, geometric shape, color, pattern, texture, and transparency and a display module communicatively coupled to the configuration module, the display module adapted to display the modified display indicia on the graphic user interface.

### CROSS REFERENCE TO RELATED DISCLOSURE

This application claims priority to U.S. provisional patent application Ser. No. 60/521,197 filed by the same inventors on Mar. 9, 2004 entitled: “Low Vision Enhancement for Graphic User Interface.”

### BACKGROUND OF INVENTION

Field of Invention

This invention relates to enhancing a graphic user interface for individuals with low vision, particularly the visibility of cursors and carets.

Definitions

Caret: An object displayed on a computer screen which denotes the text insertion point. In most computer programs, this is drawn as a blinking vertical line in a part of the screen where the user is expected to enter textual information.

Cursor: A visual item on a computer screen that moves in accordance to the instructions sent to it by a pointing device (mouse, track ball, touch pad, etc.). Typically, the cursor is used in virtually all graphical environments to perform a wide variety of tasks.

Enhancement: Special effects or visual augmentations made to the cursor or caret by the programs that implement this invention. In this context enhancement does not refer to any feature that the operating system or windowing environment may provide to alter the appearance of the caret or cursor.

Magnification Software: A computer program that, through image processing and graphical computing techniques, changes the appearance of a computer screen in order to make it more useful for people with vision impairments.

### SUMMARY OF INVENTION

The present invention is a computer software product for optimizing a graphic user interface for use by an individual with low vision. A configuration module is provided and adapted to modify the appearance of a graphic display indicia selected from the group consisting of cursors and carets. A display module communicatively coupled to the configuration module displays the modified display indicia on the graphic user interface. The display indicia may include a plurality of modifiable characteristics including height, width, line thickness, geometric shape, color, pattern, texture, shadow effects and transparency. A magnification module is provided and communicatively coupled to the display module, the magnification module having a plurality of magnification levels wherein the characteristics of the modified display indicia change responsive to a change in magnification level. The characteristics of the modified display indicia may change responsive to the movement of the display indicia, the acceleration and deceleration of the display indicia, the location of the display indicia on the graphic user interface, in response to a keyboard event, in response to a pointing device event, in response to a voice command, or in response to a predetermined idle value of the display indicia. A stored settings module is provided and communicatively coupled to the configuration module, the stored settings module adapted to store a plurality of configuration settings that represent the modified characteristics. A training module is provided communicatively coupled to the configuration module, the training module adapted to sequentially display the plurality of modifiable characteristics to the individual and record the characteristics preferred by the individual in the stored settings module. A comparative settings module communicatively coupled to the training module simultaneously displays an array of windows to the individual, each window having a distinct combination of modifiable characteristics wherein the individual selects the window with modifiable characteristics best suited for reading by the individual and the selection is recorded by the stored settings module.

In an alternative embodiment of the invention, the comparative settings module toggles a plurality of full-sized displays to the individual, each display having a distinct combination of modifiable characteristics wherein the individual selects the display with modifiable characteristics best suited for reading by the individual and the selection is recorded by the stored settings module. The plurality of full-sized display may be toggled according to a predetermined wait loop or manually toggled by user input. An advantage of this embodiment is that it overcomes a potential drawback of a simultaneous display of two or more windows wherein one window produces too much glare to discern the viability of another window that is darker. Another advantage of the this embodiment is that actual applications installed on the individual's computer may be subject to the modifiable characteristics that are toggled back and forth. Thus, the individual views the potential settings in a real operating environment and not one that is emulated by the training module.

The comparative settings module cycles through a plurality of arrays of windows until the individual selects the window with modifiable characteristics best suited for reading by the individual. The comparative settings module excludes combinations of modifiable characteristics dissimilar to a prior selection by the individual prior to displaying another array of windows to the individual.

### BRIEF DESCRIPTION OF THE DRAWINGS

For a fuller understanding of the invention, reference should be made to the following detailed description, taken in connection with the accompanying drawings, in which:

FIG. 1 is a diagrammatic view of a computer display showing a cursor at 1× magnification according to an embodiment of the invention.

FIG. 2 is a diagrammatic view of a computer display showing a cursor at 2× magnification according to an embodiment of the invention.

FIG. 3 is a diagrammatic view of a computer display showing a cursor at 4× magnification according to an embodiment of the invention.

FIG. 4 is a diagrammatic view of a computer display showing plurality of modifiable characteristics of the display indicia according to an embodiment of the invention.

FIG. 5 is a diagrammatic view of a computer display showing dynamic modification of size and fill of the display indicia responsive to movement according to an embodiment of the invention.

FIG. 6 is a diagrammatic view of a computer display showing dynamic modification of size of the display indicia responsive to idle time according to an embodiment of the invention.

FIG. 7 is a diagrammatic view of a computer display showing dynamic modification of size and fill of the display indicia responsive to various accelerations according to an embodiment of the invention.

FIG. 8 is a diagrammatic view of a computer display showing the comparative settings module displaying an array of windows, each window having a distinct combination of modifiable characteristics of background and foreground text according to an embodiment of the invention.

FIG. 9 is a diagrammatic view of a computer display showing the comparative settings module displaying an array of windows, each window having a distinct combination of modifiable characteristics of cursor shape according to an embodiment of the invention.

FIG. 10 is a diagrammatic view of a computer display showing the comparative settings module displaying an array of windows, each window having a distinct combination of modifiable characteristics of cursor fill according to an embodiment of the invention.

FIG. 11 is a diagrammatic view of a computer display showing the comparative settings module displaying an array of windows, each window having a distinct combination of modifiable characteristics of caret shape and fill according to an embodiment of the invention.

FIG. 12 is a diagrammatic view of a computer display showing an exemplary configuration of cursor and caret according to an embodiment of the invention.

FIG. 13 is a diagrammatic view of a computer display showing the comparative settings module toggling full-sized displays, each display having a distinct combination of modifiable characteristics of background and foreground text according to an embodiment of the invention.

FIG. 14 is a diagrammatic view of a computer display showing the comparative settings module toggling full-sized displays, each display having a distinct combination of modifiable characteristics of cursor shape according to an embodiment of the invention.

### DETAILED DESCRIPTION OF THE PREFERRED EMBODIMENT

Static Changes to the Appearance of the Cursor or Caret

The appearance of the cursor and caret can be altered within a magnification package. This invention includes the non-exclusive alteration of the height, width, line thickness and transparency of the cursor and caret. The user can, through a control provided in the products which employ this invention, set the persistent values for each of these characteristics.

Dynamic Changes to the Appearance of the Cursor and Caret

The user may also optionally choose to have the special characteristics of their cursor and/or caret change based upon the current modality of the system. Specifically, when the user is moving their cursor by manipulating their pointing device (mouse, track ball, etc.) they may benefit from having the static enhancements turned off or behave in a different manner depending upon the speed at which their cursor is moving on the screen. Also, the user may wish to have their caret appear one way when it is sitting still and another when they are changing the position of the caret on the screen.

It is useful for some people with diminished vision to be able to enhance the appearance of and change the size of the cursor on their computer screen. A user of this invention can adjust the height, width, line thickness and the level of transparency of the cursor and caret. The enhancements employed around the cursor and/or caret may also be modified in the same fashion, independently of the visual effects employed on the object they are enhancing.

The enhancements to the cursor and/or caret can also obscure information that is important to the user. In order to provide both the added value of making the cursor and caret easier to see, the dynamic aspect to this invention permits the user to enjoy the benefits of the cursor and Caret enhancements while in a mode where they are useful but not be inhibited by the same enhancements when their modality changes to one where the enhancements have a negative effect on their productivity.

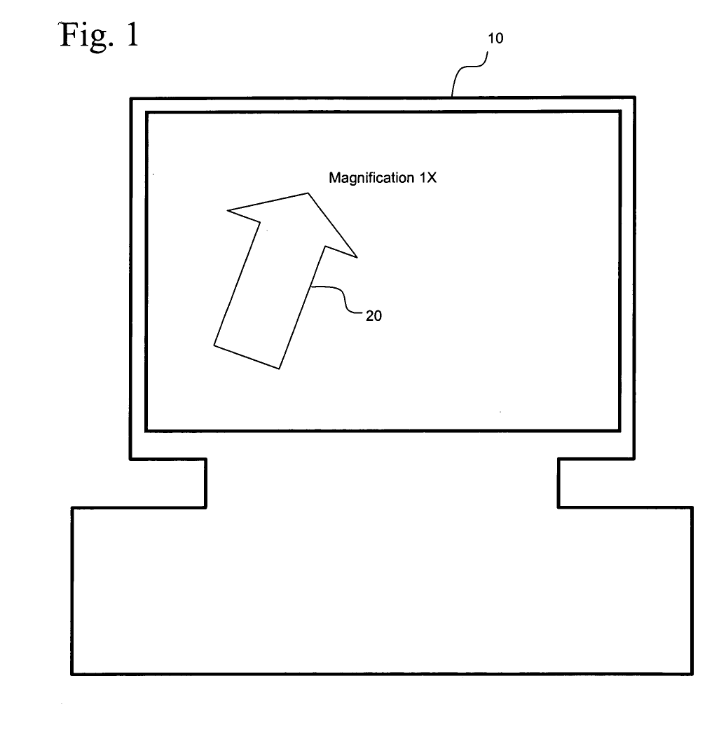

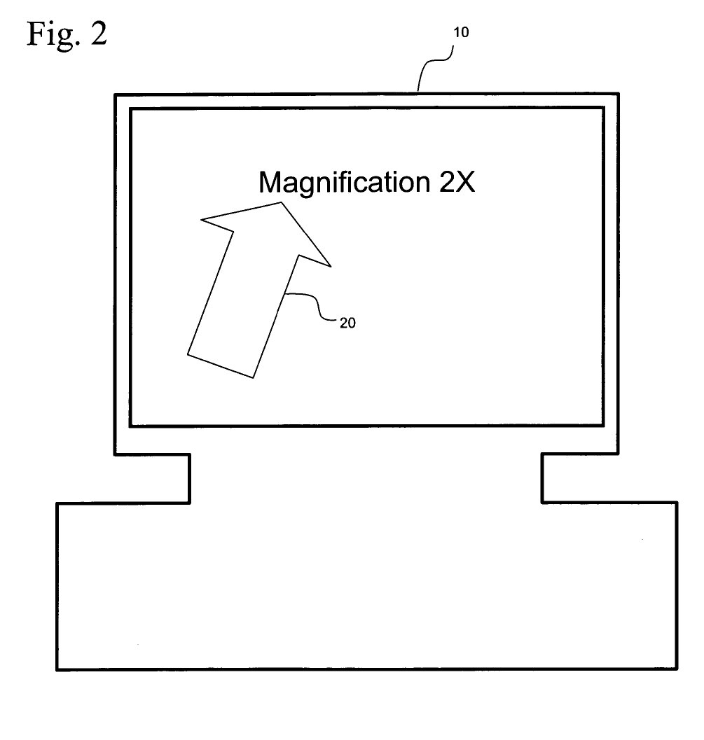

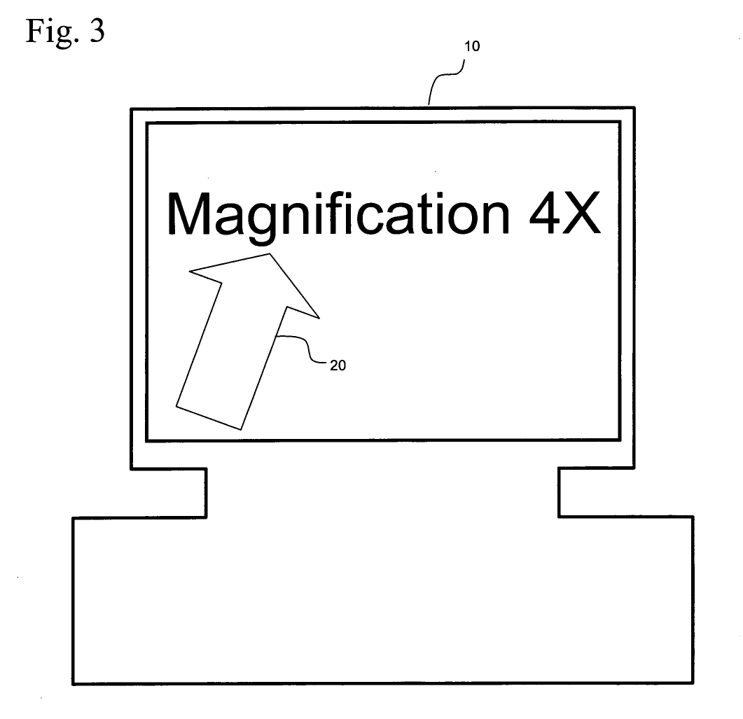

Turning to FIG. 1, display 10 may be any suitable monitor or integrated display device as known in the art. Cursor 20 is shown at 1× magnification. In FIG. 2, cursor 20 is shown at 2× magnification. In FIG. 3, Cursor 20 in shown at 4× magnification. At each magnification level shown in FIGS. 1-3, cursor 20 increases in size substantially in proportion to the magnification level. In an alternative embodiment, cursor 20 may remain a constant size regardless of magnification level.

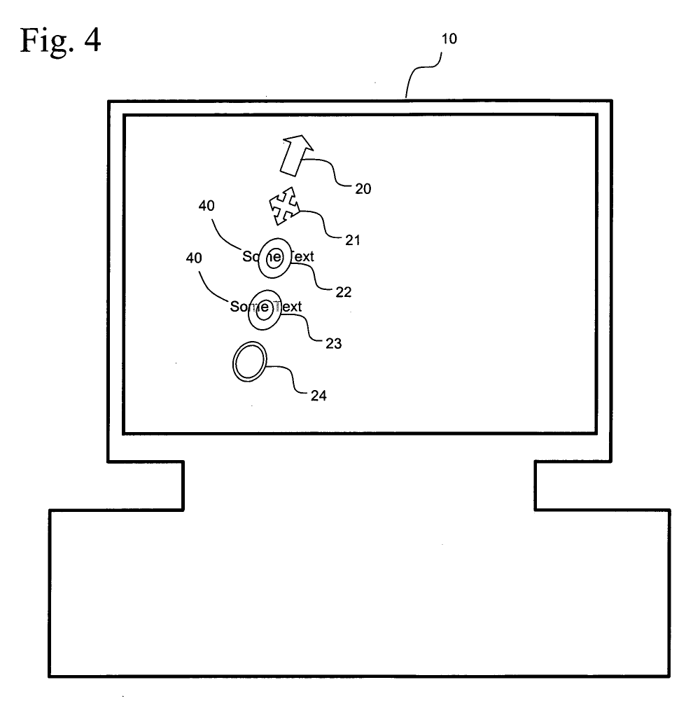

In FIG. 4, cursor shapes 20-24 are selectable by an end user observing the display. This will typically be the individual intended to use the software product for low-vision reading. While cursor shapes 22 and 23 are identical in geometric shape and dimension, cursor shape 22 is opaque while cursor shape 23 is semi-transparent whereby underlying text 40 is completely hidden by cursor shape 22 and partially hidden by cursor shape 23. While cursor shape 24 has the identical outer perimeter dimensions and shape as cursor shapes 22-23, the line thickness of cursor shape 24 has been modified to be thinner with respect to cursor shapes 22-23.

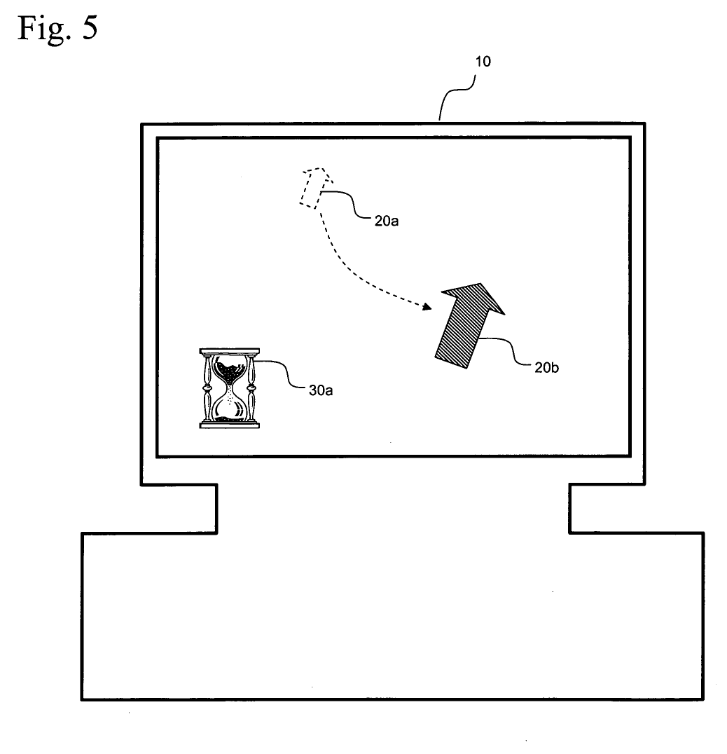

In FIG. 5, the characteristics of cursor 20a are modified to cursor 20b responsive to movement over time frame 30a. Since cursors and carets often appear small and difficult to find to low-vision users, particularly while the cursor or the caret is in motion, enlarging or otherwise changing the moving display indicia helps the low-vision user to track the location of the display indicia better than if the display indicia's characteristics remained static.

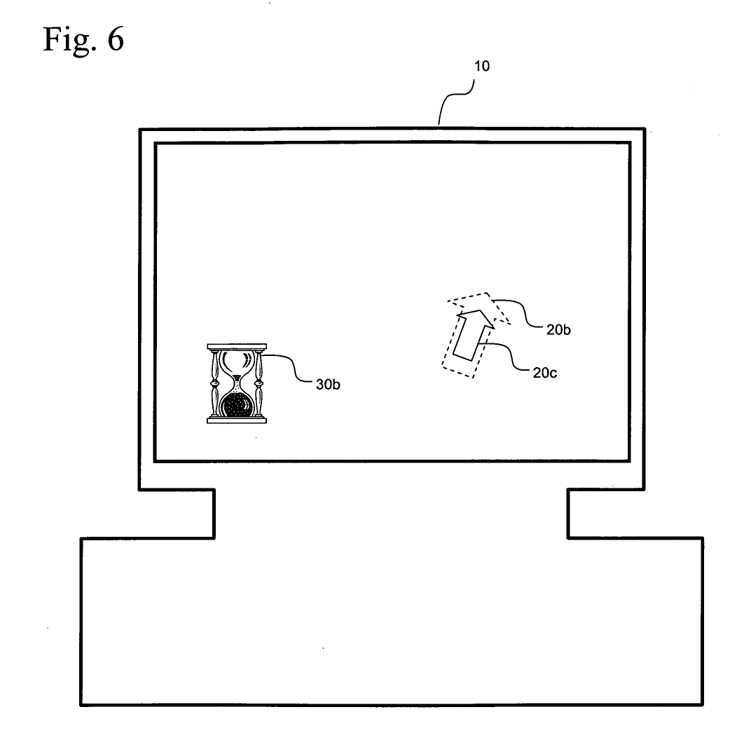

In FIG. 6 cursor 20b reduces size to cursor 20c over time period 30b responsive to a predetermined idle time. This is advantageous when the end user is no longer moving the cursor and it is desirable that the cursor be less obtrusive on the screen. In addition to size, cursor 20c may change color, fill, transparency or any other display characteristic responsive to a preset idle time on the display screen.

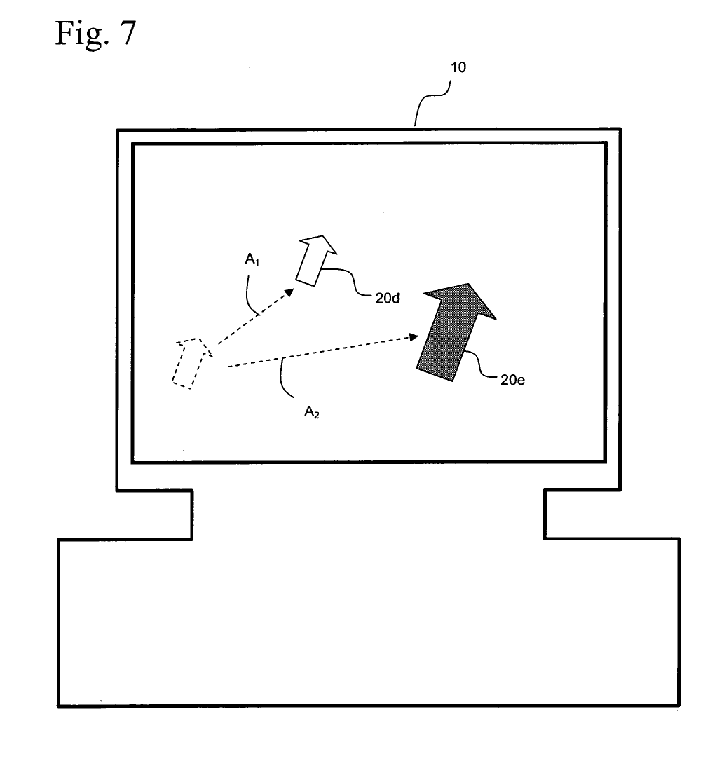

In FIG. 7, cursor 20d is accelerated at a lower rate A1 in comparison to a faster acceleration rate A2 of cursor 20e. The display characteristics of cursor 20d change less, if at all, responsive to slower rate A1 while the display characteristics of cursor 20e change more due to the faster rate A2. This is advantageous as low-vision individuals are more likely to lose track of the location of a cursor or caret the faster that it moves.

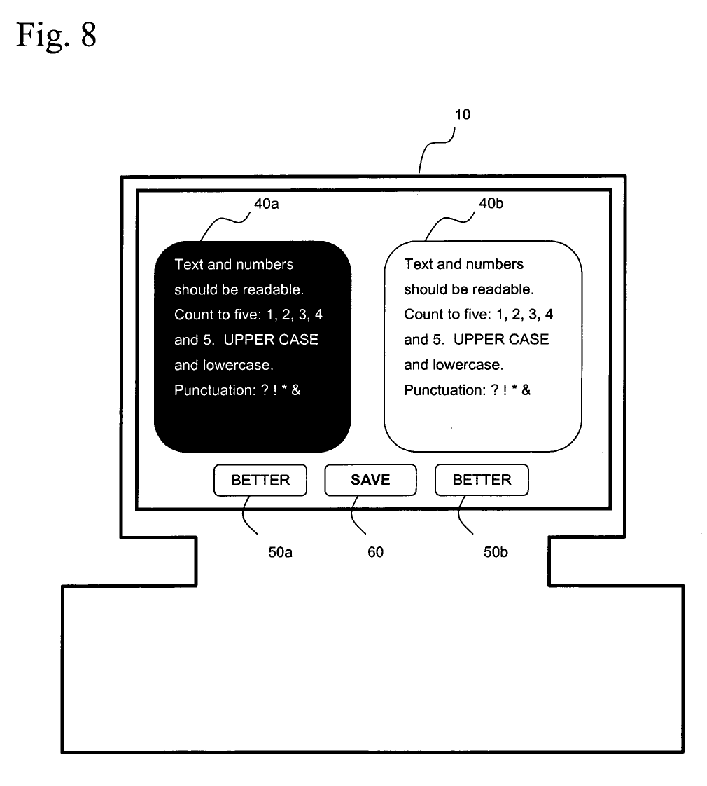

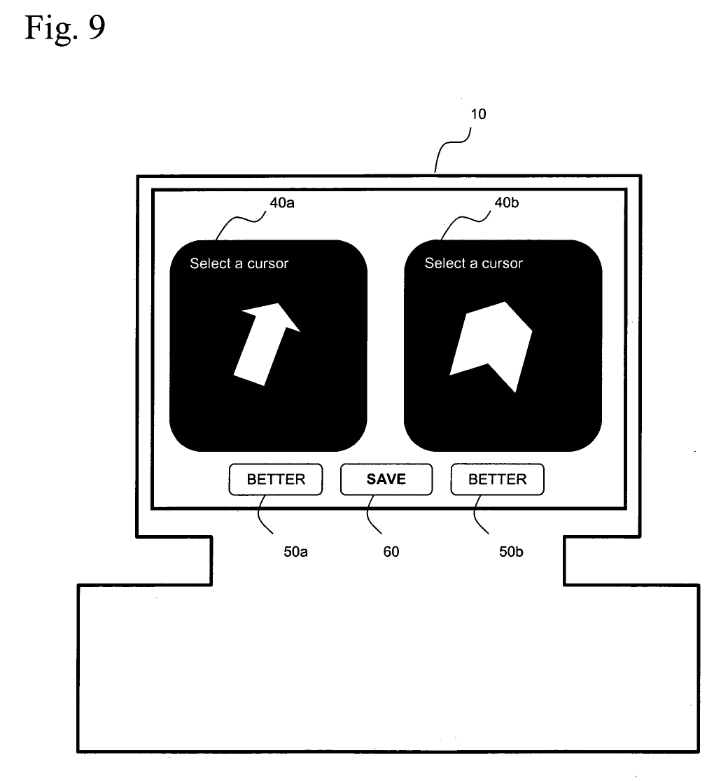

In FIG. 8, a training module is enabled to expose a low-vision individual to a number of different display configurations side-by-side in an array of windows. Window 40a displays white text over a black background while window 40b is the inverse. The low-vision individual may choose the display of window 40a by activating first selection 50a or the display of window 40b by activating second selection 50b. Alternatively, the individual may activate save selection 60 to store the current selected configuration. For the purpose of this example, the individual activated first selection 50a as she was able to read the white text on a black background better. In FIG. 9, the individual is now presented with alternative cursor shapes. However, both possible cursors are presented as white on a black background as the individual already chose that arrangement in the previous selection represented in FIG. 8. Thus, the individual preferences are propagated to subsequent displays.

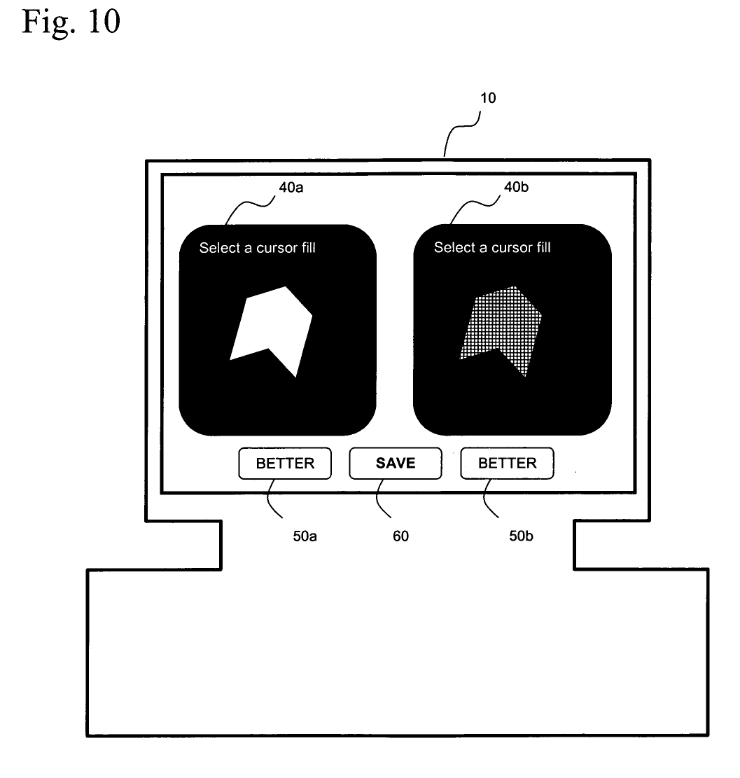

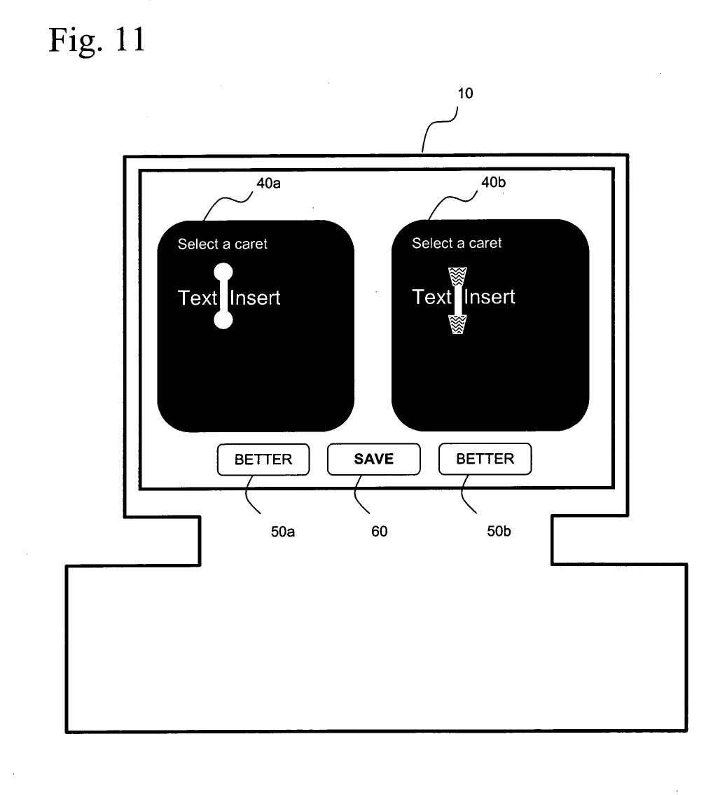

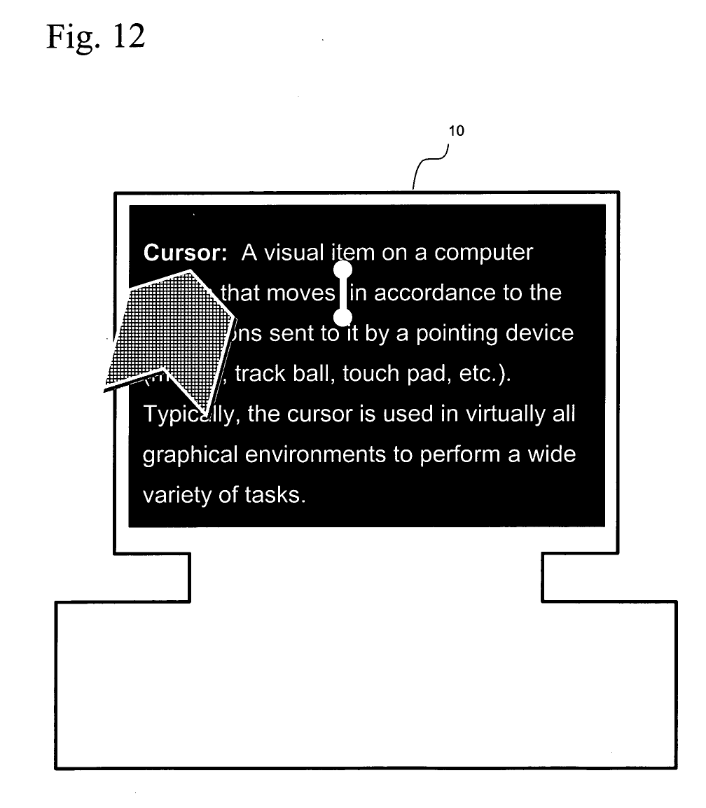

In FIG. 10, different fills of the cursor selected in FIG. 10. In window 40a the fill is solid white, while in window 40b the fill is hatched. In FIG. 11, carets of different geometric configurations and fills are presented for selection similar to the cursor selections of FIGS. 8-10. FIG. 12 illustrates use of the selected configuration on some displayed text taken from the present application.

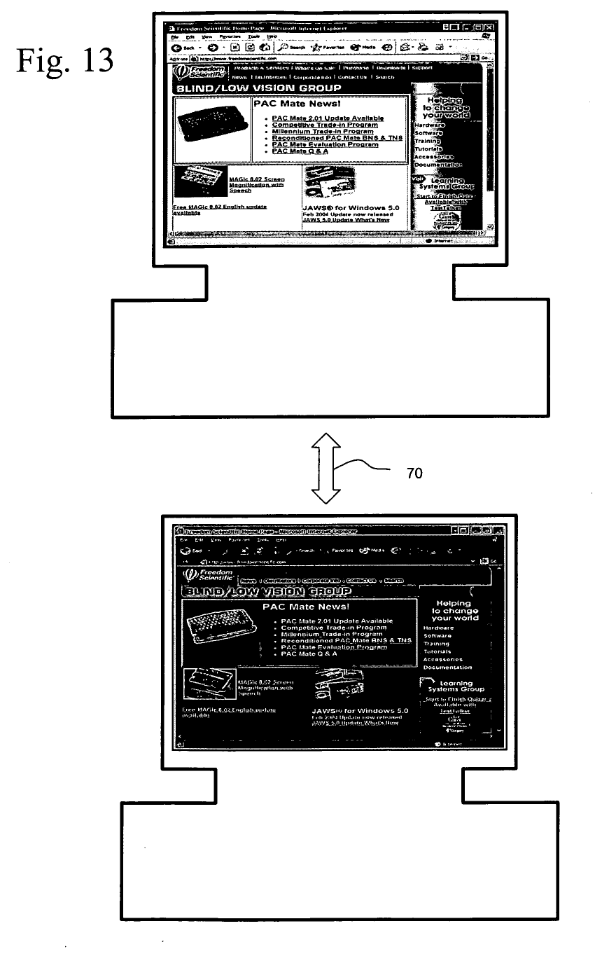

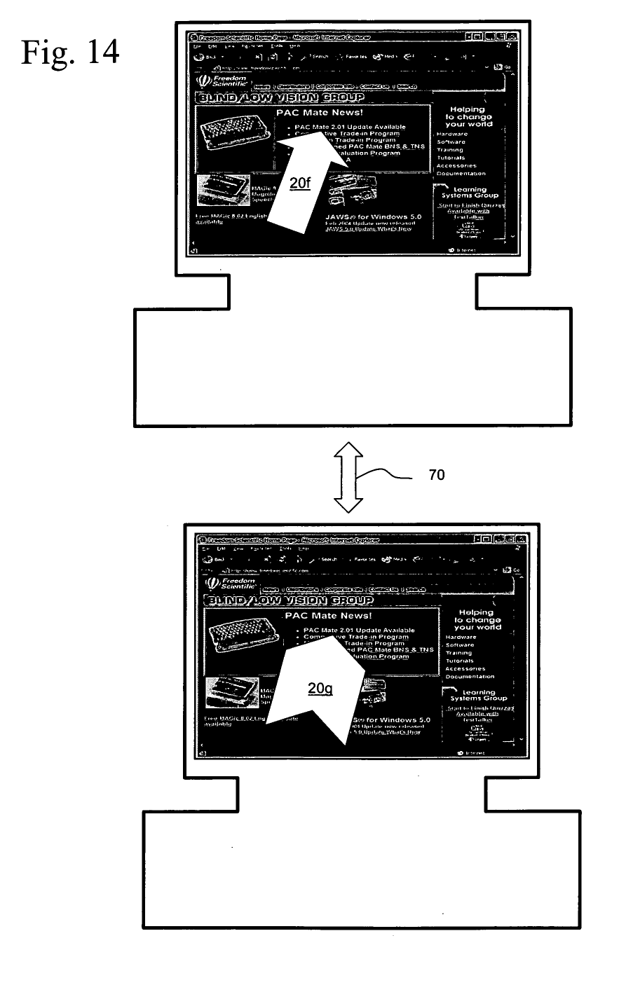

An alternative embodiment of the training module is shown in FIGS. 13-14. A full-sized display is toggled 70 back and forth either manually or by a predetermined wait loop. In FIG. 13, the background and text is normal in the upper display and inverted to a negative image in the lower display. If the upper and lower displays were presented side-by-side, the bright glare of the upper display would render the darker lower display indiscernible. As an example, the individual selected the inverted lower display which is then propagated to FIG. 14 wherein cursors 20f and 20g are presented for selection over the previously selected background configuration.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

1. A computer software product for optimizing a graphic user interface for use by an individual with low vision, the software product comprising:
a configuration module, the configuration module adapted to modify the appearance of a graphic display indicia selected from the group consisting of cursors and carets; and
a display module communicatively coupled to the configuration module, the display module adapted to display the modified display indicia on the graphic user interface.

2. The software product of claim 1 wherein the display indicia further comprising a plurality of modifiable characteristics selected from the group consisting of height, width, line thickness, geometric shape, color, pattern, texture, shadow and transparency.

3. The software product of claim 2 further comprising a magnification module communicatively coupled to the display module, the magnification module having a plurality of magnification levels wherein the characteristics of the modified display indicia are maintained regardless of change in magnification level.

4. The software product of claim 2 wherein the characteristics of the modified display indicia change responsive to the movement of the display indicia.

5. The software product of claim 4 wherein the characteristics of the modified display indicia change responsive to the acceleration and deceleration of the display indicia.

6. The software product of claim 4 wherein the characteristics of the modified display indicia change responsive to positioning the display indicia on the graphic user interface at user-defined locations.

7. The software product of claim 2 wherein the characteristics of the modified display indicia change responsive to a keyboard event.

8. The software product of claim 2 wherein the characteristics of the modified display indicia change responsive to a pointing device event.

9. The software product of claim 2 wherein the characteristics of the modified display indicia change responsive to a voice command.

10. The software product of claim 2 wherein the characteristics of the modified display indicia change responsive to a predetermined idle value of the display indicia.

11. The software product of claim 2 further comprising a stored settings module communicatively coupled to the configuration module, the stored settings module adapted to store the modified characteristics.

12. The software product of claim 10 wherein a plurality of configuration settings are saved by the stored settings module.

13. The software product of claim 11 further comprising a training module communicatively coupled to the configuration module, the training module adapted to sequentially display the plurality of modifiable characteristics to the individual and record the characteristics preferred by the individual in the stored settings module.

14. The software product of claim 13 further comprising a comparative settings module communicatively coupled to the training module, the comparative settings module simultaneously displaying an array of windows to the individual, each window having a distinct combination of modifiable characteristics wherein the individual selects the window with modifiable characteristics best suited for reading by the individual and the selection is recorded by the stored settings module.

15. The software product of claim 13 further comprising a comparative settings module communicatively coupled to the training module, the comparative settings module toggling a plurality of displays to the individual, each display having a distinct combination of modifiable characteristics wherein the individual selects the display with modifiable characteristics best suited for reading by the individual and the selection is recorded by the stored settings module.

16. The software product of claim 14 wherein the comparative settings module cycles through a plurality of arrays of windows until the individual selects the window with modifiable characteristics best suited for reading by the individual.

17. The software product of claim 15 wherein the comparative settings module excludes combinations of modifiable characteristics dissimilar to a prior selection by the individual prior to displaying another array of windows to the individual.

18. A computer software product for optimizing a graphic user interface for use by an individual with low vision, the software product comprising:
a configuration module, the configuration module adapted to modify the appearance of a graphic display indicia selected from the group consisting of cursors and carets, the display indicia further comprising a plurality of modifiable characteristics selected from the group consisting of height, width, line thickness, geometric shape, color, pattern, texture, shadow and transparency; and
a display module communicatively coupled to the configuration module, the display module adapted to display the modified display indicia on the graphic user interface.
